(19) United States
(12) Patent Application Publication
(10) Pub. No.: US 2004/0242026 A1
(43) Pub. Date: Dec. 2, 2004

(54) Vehicle cockpit system with integrated electronics

(75) Inventors: Andrew Z. Glovatsky, Plymouth, MI (US); Daniel R. Vander sluis, Plymouth, MI (US); Karen L. Chiles, Farmington, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/446,008

(22) Filed: May 27, 2003

(51) Int. Cl. H01R 33/00

(52) U.S. Cl. 439/34

(57) ABSTRACT

A cockpit system for a motor vehicle integrates the electronics into the structure of the system. The cockpit system includes a cross car beam having a strip formed on the beam. The strip is defined by a planar surface structured to physically support a wiring system. Additional attachment features are provided to further support the wiring system.

### FIELD OF THE INVENTION

The present invention relates generally to a cockpit system for a motor vehicle, and more particularly relates to integration of the mechanical and electrical structures of the cockpit system.

### BACKGROUND OF THE INVENTION

Typically, vehicles house a plurality of electronic components which must be properly wired. For example, the cockpit system typically includes instrument cluster displays, air-conditioning controls, radios, navigation systems, lighters, airbags, reading lights, and other similar devices. Generally, these electronic components each include their own housing, which is typically a large metal box. These boxes or housings provide structural support to the electrical devices and modular mounting within the vehicle. Further, the boxes may also include the provision of a human machine interface (HMI) such as the control for the radio or the like.

All of these electronic devices must be electrically interconnected and/or provided with power, which is typically accomplished by a wire harness positioned within the vehicle, typically packaged within the cockpit system. Usually, a wire harness is made with a plurality of pigtails having an electrical connector disposed at one end for connection to an electrical device such as one of those referenced above. Unfortunately, as the electronic devices increase in the instrument panel, so does the complexity of the wire harness. The complexity of the wire harness, as well as the large size and weight of the housings and electronic components, leads to larger assembly cost, weight and difficulty in packaging.

Accordingly, there exists a need for an electrical interconnection solution for the electronic devices of a vehicle that minimizes the size and weight of the cockpit system, while still providing adequate support to the electronic devices.

### BRIEF SUMMARY OF THE INVENTION

The present invention provides a cockpit system for a motor vehicle that uniquely integrates the electronics into the structure of the system. The cockpit system includes a beam having a first end and a second end spanning across the vehicle from the driver side to the passenger side. A strip is formed on the beam, the strip being defined by a planar surface extending from a position adjacent the first end to a position adjacent the second end. An instrument panel is attached to the beam and has an electronic device therein. A segment of flatwire is positioned along the strip. The strip is sized and structured to correspond to the flatwire segment which is electrically connected to the electronic device therein.

According to more detailed aspects, the beam is preferably coated with a dielectric material to prevent shorting of the flatwire segment on the beam. The dielectric material is sufficiently thin to provide thermal conductivity such that the beam operates as a heat sink for the flatwire segment. A plate may be attached to the beam having a second planar surface for receiving a second flatwire segment. The plate preferably includes an aperture, whereby the second flatwire segment includes circuitry on opposing sides of the segment which are aligned with the aperture. Further, a spacer may be attached to the beam. The spacer has a planar outer surface sized to receive another flatwire segment thereon.

The strip formed on the beam may have a variable width to correspond with flatwire segments of varying widths. The strip may include various shaped sections such as radiused, curved, inclined, declined, or horizontal sections.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a perspective view of a cockpit system constructed in accordance with the teachings of the present invention;

FIG. 2 is a perspective view of a cross car beam forming a portion of the cockpit system depicted in FIG. 1; and

FIGS. 3a and 3b are enlarged views, partially cut away, of the cross car beam depicted in FIG. 2;

FIG. 4 is a perspective view, taken from the rear, of the cockpit system shown in FIG. 1;

FIG. 5 is an enlarged view, partially cut away, of the cockpit system shown in FIG. 1; and

FIG. 6 is an enlarged view, partially cut away, of the cockpit system shown in FIG. 1.

### DETAILED DESCRIPTION OF THE INVENTION

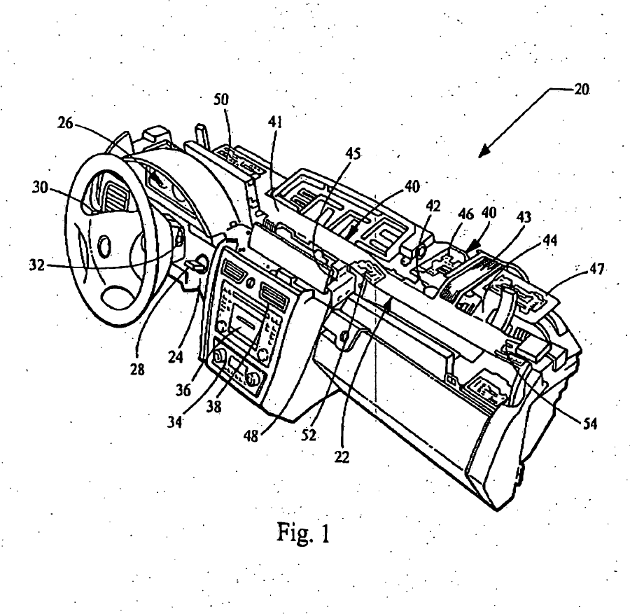

Turning now to the figures, FIG. 1 depicts a perspective view of a cockpit system 20 for a motor vehicle. The cockpit system 20 generally includes a cross car beam 22 forming a structural component of the vehicle. The cockpit system 20 also includes an instrument panel 24 having a plurality of electronic devices thereon. By way of example, the instrument panel 24 includes various display devices such as those typically found in the instrument cluster 26 such as odometer, speedometer, engine RPM, fuel level, engine temperature, and the like. Various input devices such as the ignition 28, turn signal 30, wiper control 32, and the like are also included. The electronic devices also include human machine interfaces (HMIs) such as those for the radio 34, a navigation system 36, and controls 38 for the heating and air conditioning of the vehicle. The heating, ventilation and air conditioning (HVAC) system has been generally shown at numeral 40.

Uniquely, all of these electronic components are supplied with power and are otherwise interconnected by way of a bussing system 42 which employs flatwire. As used herein, flatwire refers generally to flat cabling such as flat flexible cable, (FFC) and flat printed cable (FPC), as well as ribbon cable. Accordingly, the flatwire bus system 40 generally includes at least one flatwire segment 41, and preferably includes multiple flatwire segments including flatwire take-outs, 42, 43, 44, and 45 leading to corresponding electronic sites 46, 47, 48. Furthermore, the bussing system 40, and particularly the flatwire bus 41 may also include electronic sites 50, 52, 54 formed directly into the flatwire segment 41. Generally, the electronic sites 46, 47, 48, 50, 52, 54 are formed on a flexible substrate, preferably directly and integrally formed with the flatwire segments, and are populated with various circuitry for performing different functions. Nonetheless, the electronic sites may also be separately formed including on different substrates such as printed circuit boards. For example, each of the electronic sites may correspond to a particular electronic device or set of electronic devices such as those described above.

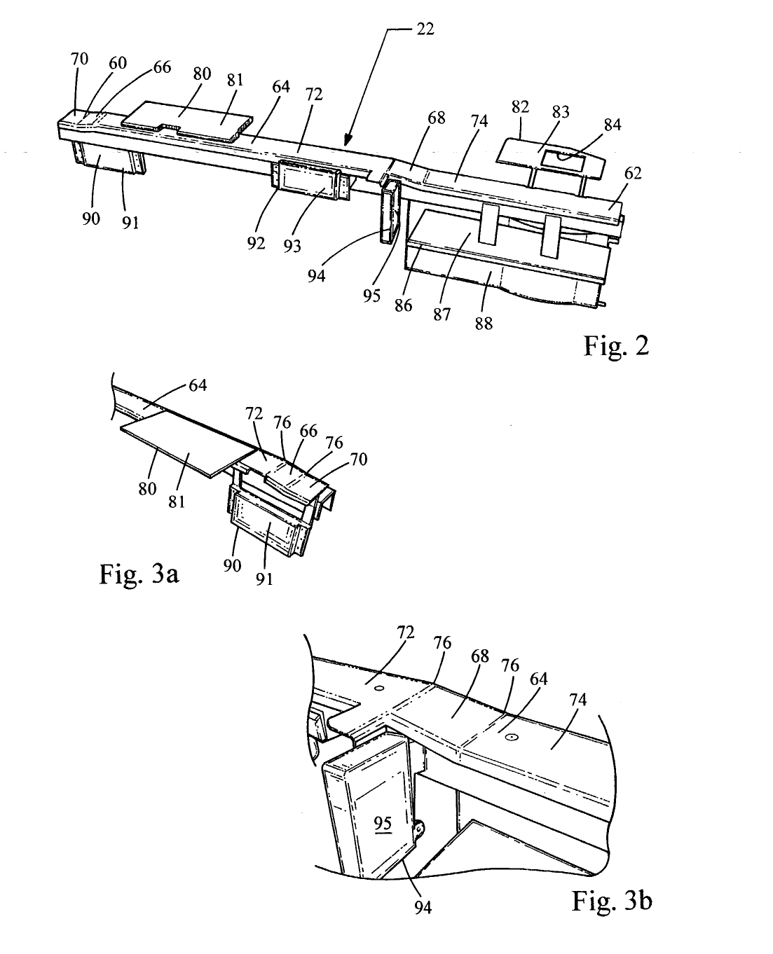

Another unique aspect of the present invention is that the cross car beam 22 has been specifically designed for the integration of the bussing system 40. That is, rather than adapt the bussing system 40 to the specific structure of a cross car beam, the cross car beam 22 is ideally constructed for integration of electronic bussing, components, and related devices. As shown in FIG. 2, a cross car beam 22 includes a first end 60 and a second end 62. The beam 22 spans from the driver side of a vehicle (not shown) to the passenger side of the vehicle and provides structural support thereto.

The cross car beam 22 has been structured to provide a continuous strip 64 spanning from adjacent the first end 60 to adjacent the second end 62. The strip 64 is defined by a planar surface spanning between the ends 60, 62. That is, the planar surface of the strip 64 is flat, i.e., at any point along its length it extends in two dimensions, although the strip 64 is allowed to vary in the third dimension. For example, the strip 64 includes an inclining section 66, a declining section 68, and can also include radiused or curved sections. In between these sections the strip 64 also includes various horizontal sections 70, 72 and 74.

The inclining and declining sections 66, 68 can be seen more clearly in the enlarged views of FIGS. 3a and 3b. Notably, the transition from horizontal sections to inclined or declined sections include radiused portions 76. The planar strip 64 may also be recessed relative to the rest of the cross car beam 22. The width of the planar strip 64 may also vary to correspond with the width of the flatwire bussing system 40. The strip 64 is sized and structured to receive a segment of flatwire. Each segment of flatwire is attached to its structural support, such as cross car beam 22, in any convention manner, such as those disclosed in co-pending U.S. patent application Ser. No. 10/292,553, the disclosure of which is hereby incorporated by reference in its entirety. Preferably, the cross car beam 22 is coated, at least in the area of the strip 64, with a dielectric material to prevent shorting of the bussing system 40. Most preferably, the coating is sufficiently thin to still allow for thermal conductivity. That is, the cross car beam 22 operates as a heat sink for the bussing system 64, and specifically for the flatwire segments 41, 42, 43, 44, 45 and the integrally formed electronic sites 46, 47, 48, 50, 52, 54.

Notably, the cross car beam 22 also includes various attachment structures to expand the possibilities of electronic integration. As shown in FIG. 2, the cross car beam 22 includes a first plate 80, a second plate 82, and a third plate 86. The first plate 80 includes a planar surface 81 while the second plate includes a planar surface 83. The second plate 82 preferably includes an aperture 84 to be discussed in more detail later herein. The third plate 84 includes a horizontal planar surface 87 and a vertical planar surface 88. The cross car beam 22 may also include various spacers such as a first spacer 90, a second spacer 92, and a third spacer 94. The spacers 90, 92, 94 include outer surfaces that are planar for receiving flatwire bussing.

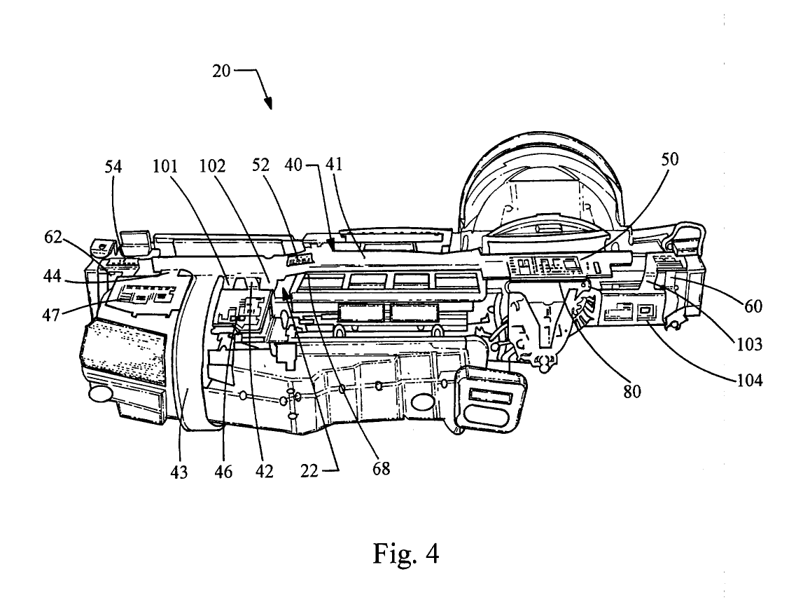

Turning now to FIG. 4, a rear view of the cockpit system 20 is shown. The cross car beam 22 receives the bussing system 40 and particularly the flatwire bus segment 41 between the first and second ends 60, 62. The aforementioned electronic sites 50, 52, and 54 are supported directly on the cross car beam 22 and the planar strip 64, including on declined section 68. Additional flatwire take-outs 101, 102 can be seen, as well as a take-out 103 which leads to an additional electronic site 104. It can also be seen that the electronic site 50 and the surrounding portion of the flatwire segment 41 is physically supported on the first attachment plate 80 and its planar support surface 81.

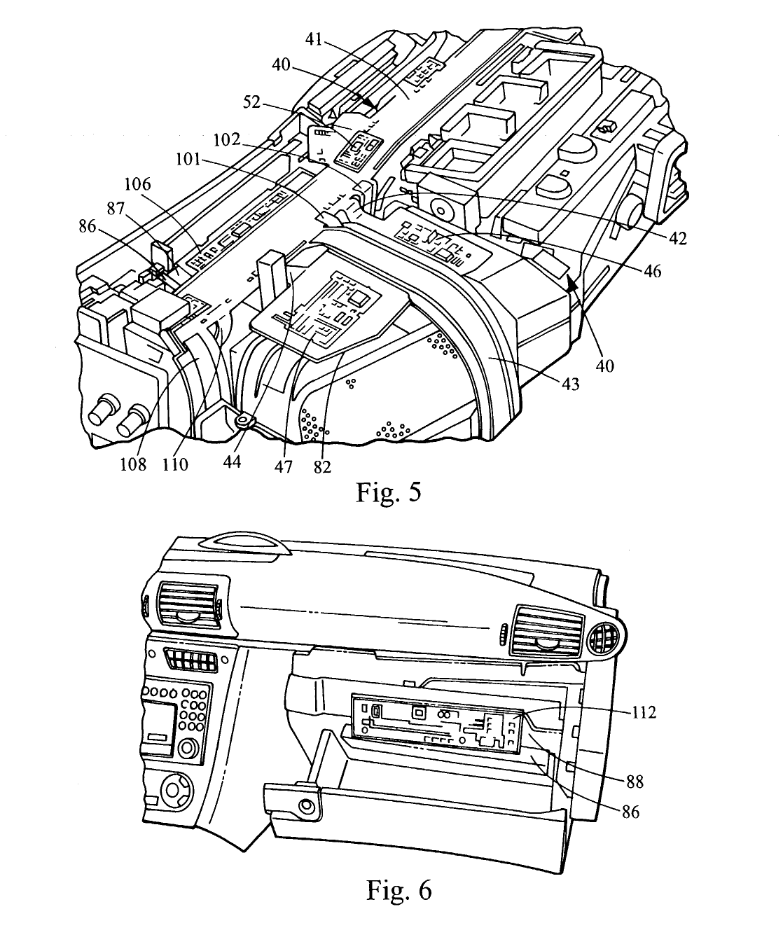

Likewise, and as best seen in the enlarged view of FIG. 5, the electronic site 47 is supported directly on the second attachment plate 82. Preferably, the electronic site 47 is a double-sided site, meaning that circuitry is populated on both sides of the flatwire. The electronic components on the lower side of the site 47 extend through the aperture 84 formed in the plate 82, as best seen in FIG. 2. It can also be seen that flatwire take-out 43 actually extends along the outer housing of the HVAC unit 40. Similarly, the electronic site 46 is also directly supported on the housing of the HVAC unit 40.

Yet another electronic site 106 is supported on the third plate 86, and more particularly the horizontal surface 87. The third support plate 86 actually forms a portion of the glove box compartment. Finally, additional flatwire take-outs 108 and 110 can be seen which lead to additional electronic sites or devices (not shown). As shown in FIG. 6, yet another electronic site 112 is shown mounted to the vertical portion 88 of the third attachment 86 within the glove box compartment.

Accordingly, the cockpit system 20 of the present invention provides an electrical interconnection solution for the electronic devices of a vehicle that minimizes the size and weight of the cockpit system, while still providing adequate support to the electronic devices. The cross car beam 22 is uniquely formed to provide physical support to the flatwire bussing system, both mechanically and thermally. Additional attachment features provide a robust cockpit system 20 having numerous planar surfaces for supporting the flatwire and its integrated electronic sites for operation of the various electronic devices in the system. In this way, size and weight are minimized, while physical support of the bussing/wiring system is improved.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A cockpit system for a motor vehicle, the cockpit system comprising:
a beam having a first end and a second end spanning across the vehicle from the driver's side to the passenger side;
a strip formed on the beam, the strip defined by a planar surface extending from a position adjacent the first end to a position adjacent the second end;
an instrument panel attached to the beam, the instrument panel having an electronic device therein;
a segment of flatwire positioned along the strip, the strip sized and structured to correspond to the flatwire segment, the flatwire segment electrically connected to the electronic device; and
a layer of dielectric material coating the strip to insulate the segment of flatwire.

2. The cockpit system of claim 1, wherein a portion of the beam adjacent the strip is coated with a dielectric material to prevent shorting of the flatwire segment on the beam.

3. The cockpit system of claim 1, wherein the dielectric material is sufficiently thin to provide thermal conductivity.

4. The cockpit system of claim 1, further comprising a plate attached to the beam, the plate having a second planar surface for receiving a second flatwire segment.

5. The cockpit system of claim 4, wherein the plate includes an aperture, and wherein the second flatwire segment includes electronic circuitry on opposing sides of the second flatwire segment.

6. The cockpit system of claim 4, wherein the plate is spaced vertically from the beam.

7. The cockpit system of claim 1, further comprising a spacer attached to the beam, the spacer having a planar outer surface sized to receive a second flatwire segment thereon.

8. The cockpit system of claim 1, wherein the flatwire segment includes an electronic site formed into the flatwire segment, the electronic site operatively connected to the electronic device.

9. The cockpit system of claim 8, wherein the electronic site has a flexible substrate.

10. The cockpit system of claim 8, wherein the electronic site has a rigid substrate.

11. A cockpit system for a motor vehicle, the cockpit system comprising:
a beam having a first end and a second end spanning across the vehicle from the driver's side to the passenger side;
a strip formed on the beam, the strip defined by a planar surface spanning from a position adjacent the first end to a position adjacent the second end, the strip sized and structured to receive a segment of flatwire; and
the strip being recessed relative to the surrounding portion of the beam.

12. (Cancelled)

13. The cockpit system of claim 11, wherein the strip has a variable width.

14. The cockpit system of claim 11, wherein the strip includes a radiused section.

15. The cockpit system of claim 11, wherein the strip includes a curved section.

16. The cockpit system of claim 11, wherein the strip included an inclined section.

17. The cockpit system of claim 1, wherein the strip includes a declined section.

18. The cockpit system of claim 1, wherein the strip includes a horizontal section.

19. A cockpit system for a motor vehicle, the cockpit system comprising:
a beam having a first end and a second end spanning across the vehicle from the driver's side to the passenger side;
a strip formed on the beam, the strip defined by a planar surface extending from a position adjacent the first end to a position adjacent the second end;
an instrument panel attached to the beam, the instrument panel having an electronic device therein;
a segment of flatwire positioned along the strip, the strip sized and structured to correspond to the flatwire segment, the flatwire segment electrically connected to the human machine interface; and
a plate attached to the beam, the plate having a second planar surface for receiving a second flatwire segment.

20. Th cockpit system of claim 19, wherein the beam is coated with a dielectric material to prevent shorting of the flatwire segment to the beam.

21. A cockpit system of claim 19, wherein the second planar surface defines an aperture, and wherein the second flatwire segment includes electronic circuiting on opposing sides, the electronic circuitry on one side being positioned within the aperture
